(19) United States
(12) Patent Application Publication
(10) Pub. No.: US 2026/0145094 A1
(43) Pub. Date: May 28, 2026

(54) ORIGAMI FOR THE VISUALLY IMPAIRED

(71) Applicants: Cole Brown, Edgewood, KY (US); Andrew Garamy, Crescent Springs, KY (US); Ethan Ginn, Villa Hills, KY (US); Emily Vick, Crescent Springs, KY (US); Luke Wood, Crescent Springs, KY (US)

(72) Inventors: Cole Brown, Edgewood, KY (US); Andrew Garamy, Crescent Springs, KY (US); Ethan Ginn, Villa Hills, KY (US); Emily Vick, Crescent Springs, KY (US); Luke Wood, Crescent Springs, KY (US)

(21) Appl. No.: 19/401,579

(22) Filed: Nov. 26, 2025

Related U.S. Application Data
(60) Provisional application No. 63/725,251, filed on Nov. 26, 2024.

(51) Int. Cl. A63H 33/16; G09B 19/10

(52) U.S. Cl. CPC A63H 33/16; G09B 19/10

(57) ABSTRACT

A kit and method are disclosed for enabling a person with a visual impairment to create an origami structure through guided, tactilely assisted folding. The method includes delivering audio instructions that directs the user through a series of sequential folding and shaping actions. In response to the instructions, the user selects a jig having a configuration, corresponding to a specific origami design, and selects a paper element characterized by particular shapes, sizes, or tactile features suited to the desired result. The user positions the selected jig onto the paper and performs a guided sequence of folds, bends, and shaping actions relative to the jig, guided with audio instructions. The kit may include the plurality of jigs, tactilely differentiated paper elements, and an audio instruction system for facilitating independent, repeatable origami creation by visually impaired users.

### CROSS REFERENCE TO RELATED APPLICATIONS

This application claims priority to U.S. Patent Application Ser. No. 63/725,251, filed on Nov. 26, 2024, entitled “ORIGAMI FOR THE VISUALLY IMPAIRED”, which is incorporated by reference herein in its entirety.

### FIELD OF INVENTION

The present invention relates to a kit and method for the making of origami structures by visually impaired persons.

### BACKGROUND

Origami, the traditional Japanese art of paper folding, has a rich and fascinating history. In the traditional sense, origami typically involves folding a single sheet of square paper, with no cutting or gluing. Over time, origami artists began experimenting with more advanced techniques, creating models with multiple pieces of paper, and using cutting and gluing methods to create even more detailed sculptures.

While it is associated with Japan, origami traditions and techniques have evolved in various cultures over centuries. Origami has gained global recognition and inspired innovations in mathematics, engineering, and design. Modern origami blends traditional Japanese techniques with contemporary artistry and influences from around the world. Today, origami is celebrated as both a cultural tradition and a creative art form, with applications ranging from fine art to practical fields like architecture, robotics, and aerospace. Techniques inspired by origami have been used in space exploration (foldable solar panels) and in designing compact structures like stents in medical devices.

Origami has typically required a keen sense of sight to practice. Embodiments of the present disclosure provide a kit and method of practicing origami for the visually impaired.

### SUMMARY

Presently disclosed is a kit and method for the visually impaired to make a figure or structure with origami. In at least one embodiment, the kit comprises shaped and sized paper, a jig, and audio instructions. The presently disclosed kit enables one with a visual impairment to make a cup with origami. It is to be understood that the presently disclosed example of the kit and method for the visually impaired is not to limit the present disclosure. For example, the kit may comprise a plurality of jigs, papers, and instructions for the construction of a variety of structures.

In at least one embodiment of the present disclosure, a method for the visually impaired to make a cup with origami is disclosed. The method comprises playing time-sequenced audio instructions for a visually impaired person to make the origami structure, upon listing to the time-sequenced audio instructions, wherein upon listening to the time-sequenced audio instructions the person performs the steps of: placing a shaped piece of paper onto a flat surface; folding and creasing the piece of paper a first instance to form a first crease that functions as a guiding crease and that completely extends between outer edges of the piece of paper; unfolding the piece of paper; placing a jig on the piece of paper and aligning a first linear edge of the jig with the first crease; folding the piece of paper along the first crease and placing a portion of the piece of paper over the jig; centering the jig within the folded piece of paper so that a first corner and a second corner beyond sides of the jig and extending a first flap and a second flap beyond a top of the jig; folding and creasing the first corner of the paper about a second linear edge of the jig and forming a first side edge of the cup; folding and creasing the second corner of the paper about a third linear edge of the jig and forming a second side edge of the cup; folding the first flap outwardly and down; folding the second flap outwardly and down; removing the jig from a top opening between the first side edge and the second side edge; and squeezing the first side edge toward the second side edge and forming the cup.

In at least one other embodiment of the present disclosure, a method for enabling a person with a visual impairment to create an origami structure is disclosed. The method comprises: playing audio instructions to the person, the audio instructions prompting the person to perform sequential folding and shaping actions; selecting, in response to the audio instructions, one option from a plurality of jigs having differing configurations, each configuration being associated with formation of a different origami design; selecting, in response to the audio instructions, one option from a plurality of paper elements having differing shapes, sizes, or tactile attributes for producing a desired origami result; placing the selected paper element onto a working surface as instructed; positioning the selected jig on the paper element and aligning one or more functional edges or functional surfaces of the jig with one or more regions of the paper element as directed by the audio instructions; performing a sequence of folding actions in accordance with the audio instructions, the sequence comprising folding, bending, or shaping portions of the paper element relative to the jig; removing the jig from the partially formed paper structure once the instructed folding sequence relative to the jig has been completed; and finalizing the origami structure by folding, adjusting, pressing, or configuring the folded paper into the three-dimensional arrangement corresponding to the design selected through the audio instructions.

In at least one further embodiment of the present disclosure, a kit for enabling a person with a visual impairment to create an origami structure is disclosed. The kit comprises: a plurality of jigs having differing configurations, each configuration being associated with formation of at least one origami design and having one or more functional edges or functional surfaces configured to provide tactilely perceptible boundaries; a plurality of paper elements having differing shapes, sizes, or tactile attributes for producing different origami results, each paper element having a perimeter or at least one tactilely perceptible feature configured to be sensed by touch by the person; and an audio instruction resource configured to play audio instructions to the person, the audio instructions being associated with the plurality of jigs and the plurality of paper elements and being arranged to prompt the person to: select, in response to the audio instructions, one of the plurality of jigs; select, in response to the audio instructions, one of the plurality of paper elements; place the selected paper element onto a working surface as instructed; position the selected jig on the selected paper element and align one or more of the functional edges or functional surfaces of the jig with one or more regions of the paper element as directed by the audio instructions; perform a sequence of folding actions in accordance with the audio instructions, the sequence including folding, bending, or shaping portions of the paper element relative to the jig and defining fold locations by tracing, pressing, or following the functional edges or functional surfaces of the jig; remove the jig from a partially formed paper structure once an instructed folding sequence relative to the jig has been completed; and finalize the origami structure by folding, adjusting, pressing, or configuring the folded paper into a three-dimensional arrangement corresponding to a design associated with the selected jig and the selected paper element.

### BRIEF DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 shows an example of an embodiment of the presently disclosed origami kit for the visually impaired;

FIGS. 2A and 2B show an example of an embodiment of the presently disclosed origami method for the visually impaired;

FIGS. 3A-3C show examples of embodiments of a jig that may be a part of the presently disclosed origami kit for the visually impaired; and

### DISCLOSURE

Presently disclosed is an origami kit and method for the visually impaired. In at least one embodiment, a kit comprises a square piece of paper, a trapezoidal shaped jig, and instructions. The instructions may be audio, written, or both. The written instructions may be textual, Braille, or both. In at least one aspect, the instructions are solely in audio form.

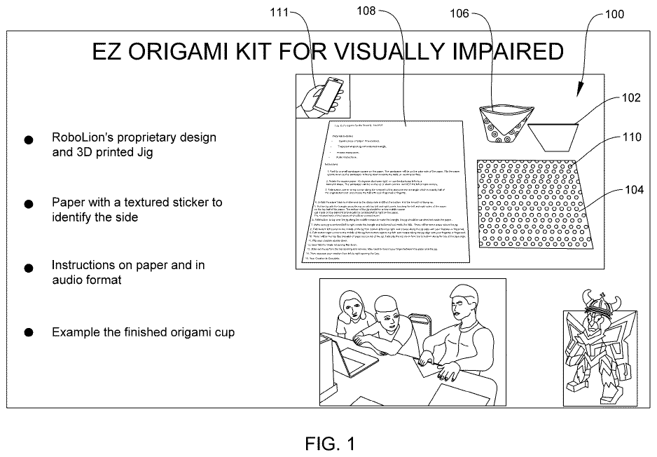

FIG. 1 shows an embodiment of the presently disclosed origami kit for the visually impaired. In the present example, the kit may comprise a square piece of paper, a trapezoid shaped jig, and audio instructions. Printed instructions may also be a part of the kit. The square piece of paper may have a colored or a design on one or both sides. The square piece of paper may have sides of about 17.5 cm. In at least one embodiment, the square paper may have a physical element configured for a feel indicator for its side. For example, the square paper may have a colored side and an opposite side with a feel indicator. The physical element may comprise a rough portion, like sandpaper, or an embossment, for example. The physical element may be disposed off center, or proximate one or more corners. For example, the physical element may provide one with visual impairment a means to face the paper on a surface with a colored side up, down, and/or identify a selected corner or edge of the paper. In at least one embodiment, the square piece of paper has a rough physical element proximate opposite corners.

FIG. 1 illustrates an embodiment of the kit 100 comprising, among other elements, a jig 102, a paper element 104, an origami structure 106, printed instructions 108, and an audio instruction resource 111. The kit elements or contents are configured to enable formation of an origami structure by a visually impaired user.

It is to be understood that the presently described piece of paper is but an example of a shape of the paper for folding and forming the origami structure. The presently disclosed kit may comprise a plurality of pieces of paper for making more than one origami structure or for making an origami structure with more than one piece of paper. The provided piece(s) of paper may have a variety of shapes, sizes, or colors. Also shown in FIG. 1 is an example jig, printed instructions, and a completed example origami structure in the form of a cup.

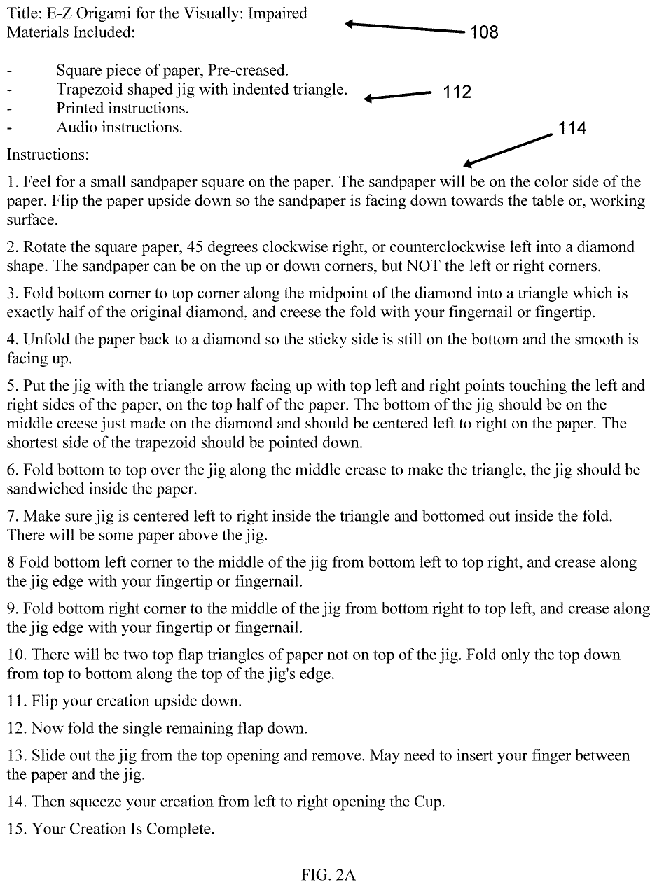

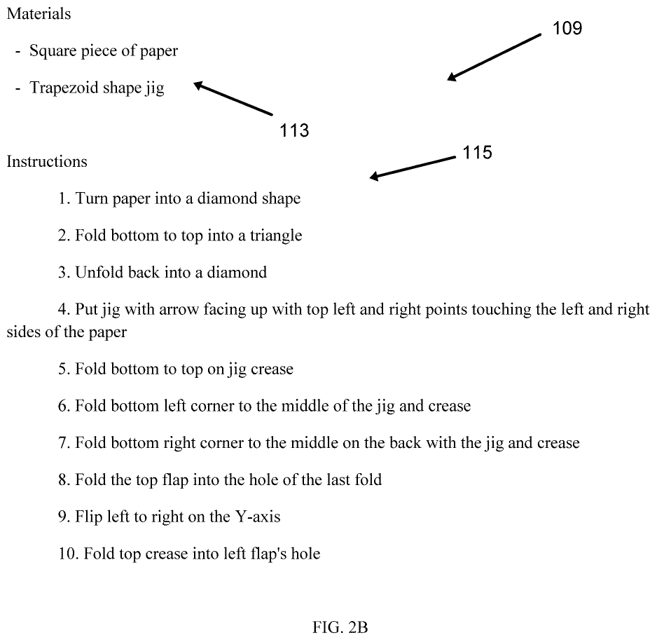

FIGS. 2A and 2B show examples of printed instructions that may be included in the presently disclosed origami kit for the visually impaired. In at least one embodiment, FIGS. 2A and 2B show embodiments of the presently disclosed origami method and kit contents for the visually impaired.

The audio instructions included with the kit may correspond with the printed instructions, providing the visually impaired with instructions or steps to build the example origami design. The instructions provide for method steps to be taken to make the origami design.

FIG. 2A depicts printed instructions 108, a kit contents list 112, and printed steps or instructions 114, while FIG. 2B depicts printed instructions 109, a kit contents list 113, and printed steps or instructions 115. These figures illustrate exemplary instructional materials that are configured to prompt or direct the user to perform sequential folding or shaping steps.

Presently disclosed is a method for making an origami structure for the visually impaired. In an exemplary illustration, the method may comprise: 1) Rotating a square piece of paper into a diamond orientation having its corners disposed up, down, right, and left; 2) Folding bottom corner, or corner nearest the user, to the top corner along the mid-section of the diamond shape and into a triangle. The triangle comprises half of the original diamond configuration; 3) Creasing the fold with a fingernail or fingertip; 4) Unfolding the square piece of paper back to the diamond configuration; 5) Putting a jig on the square piece of paper with its short base aligned with the crease and having its top left and right corners of the long base touching the upper left and right edges of the square piece of paper in the diamond orientation. The jig will be on the top half or top triangle of the square piece of paper. The bottom of the jig, or short base, should be on the middle crease just made on the diamond and be centered left to right on the paper. The shorter side, or short base, of the trapezoid should be pointed down or toward the user; 6) Folding the bottom of the square piece of paper to the top and over the jig along the middle crease to make the triangle again. The jig is sandwiched inside the paper; 7) Assuring that the jig is centered left to right inside the triangle and bottomed out inside the fold. The jig should not extend beyond the edges of the paper and there will be some paper extending beyond the jig; 8) Folding the bottom left corner of the paper toward the middle of the jig, from the paper's bottom left toward the top right, and creasing along the jig edge with a fingertip or fingernail; 9) Folding the bottom right corner of the paper toward the middle of the jig, from the paper's bottom right toward the top left, and creasing along the jig edge with a fingertip or fingernail. There will be two top flap triangles of the paper extending beyond top or long base of the jig; 10) Folding one top flap outwardly and down from top edge of the jig and toward the bottom, along the top edge of the jig; 11) Flipping the creation over; 12) Folding the other top flap outwardly and down from top edge of the jig and toward the bottom, along the top edge of the jig; 13) Sliding the jig out from the top opening of the creation and removing. Fingers may need to insert between the paper and the jig; and 13) Squeezing the side edges of the creation together and forming a cup having a top opening, thus completing the origami creation.

In at least one embodiment, the method comprises: 1) Feeling a physical element on a square piece of paper. 2) Flipping the paper upside down so that the physical element is facing down towards a table or working surface. 3) Rotating the square piece of paper 45 degrees, clockwise or counterclockwise, into a diamond shape or having its corners disposed up, down, right, and left. The physical element may be disposed proximate a top or bottom corner. 3) Folding the bottom corner, or corner nearest the user, to the top corner along the mid-point of the diamond shape and into a triangle. The triangle comprises half of the original diamond shape. 4) Creasing the fold with the user's fingernail or fingertip. 5) Unfolding the square piece of paper back to the diamond shape so that the physical element remains facing down towards the table or working surface. 6) Putting a trapezoidal jig on the square piece of paper with its short base aligned with the crease and having its top left and right corners of the long base touching the upper left and right edges of the square piece of paper. The jig will be on the top half or top triangle of the square piece of paper. The bottom of the jig, or short base, should be on the middle crease just made on the diamond and be centered left to right on the paper. The shorter side or short base of the trapezoid should be pointed down or toward the user. A physical element on the jig may help aid in the placement of the jig on the square piece of paper. 7) Folding the bottom of the square piece of paper to the top and over the jig and along the middle crease to make the triangle again. The jig is sandwiched inside the paper. 8) Assuring that the jig is centered left to right inside the triangle and bottomed out inside the fold. The jig should not extend beyond the edges of the paper and there will be some paper above the jig. 9) Folding the bottom left corner of the paper toward the middle of the jig, from bottom left toward the top right, and creasing along the jig edge with your fingertip or fingernail. 10) Folding the bottom right corner of the paper toward the middle of the jig, from bottom right toward the top left, and creasing along the jig edge with your fingertip or fingernail. There will be two top flap triangles of the paper extending beyond top of the jig. 11) Folding one top flap outwardly and down from top edge of the jig and toward the bottom, along the top edge of the jig. 12) Flipping the creation over. 13) Folding the other top flap outwardly and down from top edge of the jig and toward the bottom, along the top edge of the jig. 14) Sliding the jig out from the top opening and removing. You may need to insert your finger to between the paper and the jig. 15) Squeezing the creation from left to right to form a cup having a top opening. The creation is complete.

It is to be understood that the dimensions of the jig and the dimensions of the square piece of paper, in the cup embodiment, are relative or dependent upon each other. For example, a larger piece of paper may require a larger jig. One side of the jig may have a physical element configured for a feel indicator for its side. For example, the jig may have a triangular indentation or other physical features. A feel indicator may aid one with a visual impairment to orientate the jig for the making of the origami structure.

In at least one embodiment, a kit for making a cup is provided.

### Materials Included:

Square piece of paper with a sticky colored side, an opposite slick side, and pre-creased.
Trapezoid shaped jig with indented triangle.
Printed instructions.
Audio instructions.

### Instructions

1. Flip paper so the slippery side is up, and the sticky colored side is down.
2. Rotate square paper, 45 degrees clockwise right, or counterclockwise left into a diamond shape.
3. Fold bottom corner to top corner along the mid-point of the diamond into a triangle which is exactly half of the original diamond, and crease the fold with your fingernail or fingertip.
4. Unfold the paper back to a diamond so the sticky side is still on the bottom and the smooth side is facing up.
5. Put the jig with the triangle arrow facing up with top left and right points touching the left and right sides of the paper, on the top half of the paper. The bottom of the jig should be on the middle crease just made on the diamond and should be centered left to right on the paper. The shortest side of the trapezoid should be pointed down.
6. Fold bottom to top over the jig along the middle crease to make the triangle again, the jig should be sandwiched inside the paper.
7. Make sure jig is centered left to right inside the triangle and bottomed out inside the fold. There will be some paper above the jig.
8. Fold bottom left corner to the middle of the jig from bottom left to top right, and crease along the jig edge with your fingertip or fingernail.
9. Fold bottom right corner to the middle of the jig from bottom right to top left, and crease along the jig edge with your fingertip or fingernail
10. There will be two top flap triangles of paper not on top of the jig. Fold only the top flap down from top to bottom along the top of the jig's edge.
11. Flip your creation upside down.
12. Now fold the single remaining flap down.
13. Slide out the jig from the top opening and remove. May need to insert your finger to between the paper and the jig.
14. Then squeeze your creation from left to right opening the cup.
15. Your Creation Is Complete

It is to be understood that the dimensions and shape of the paper are variable or could be any irregular cutout shape, thickness, multiple thicknesses or a plurality of different papers configured to secured together to facilitate the origami. The jig or jigs may be volumetric or cubical in nature. One or more jigs may have extrusions, holes, or slots. One or more jigs may have interlocking means to connect a plurality of jigs together. Jigs may have features to hold, locate, or position the paper for folding. One or more jigs may work singularly or in conjunction together. The paper and/or jigs may be configured to be oriented with the use of feel or tactile. For example, a geometric shaped paper or jig may be oriented with its outer perimeter or with a physical element.

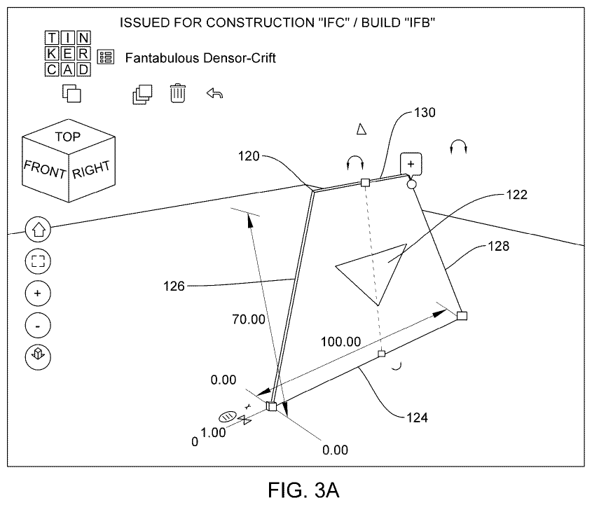

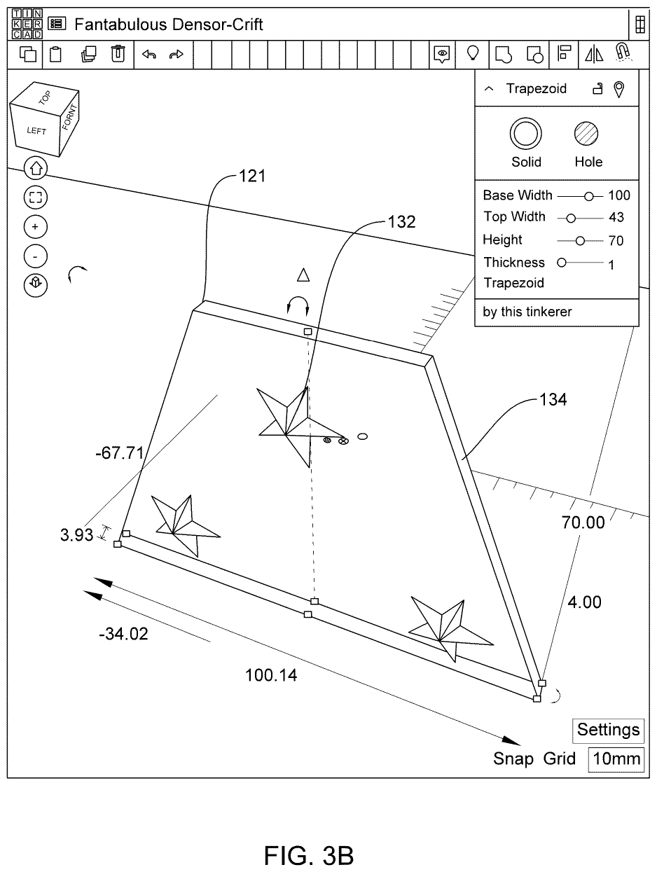

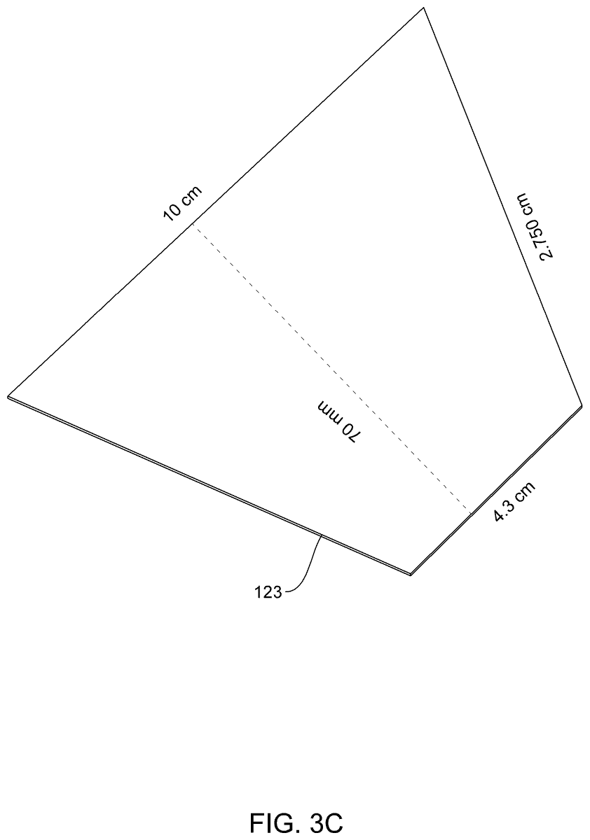

FIGS. 3A-3C show embodiments of a jig that may be a part of the presently disclosed origami kit for the visually impaired. The jig is a solid structure configured for folding paper therewith. For example, the jig may comprise a polymeric or wood material. In the present example, the jig may have a trapezoidal configuration with a short base, a parallel long base, and a height therebetween. In at least one embodiment, the jig is a trapezoid with a long base of about 10 cm and the parallel short base, which may have a length of about 4 cm, or about 4.3 cm. The height of the jig extends between the short base and the long base. The sides of the trapezoidal jig are of equally length.

FIG. 3A shows an embodiment of a jig 120 having one or more tactile or functional surfaces, including a jig tactile feature 122, a first side 124, second sides 126 and 128, and a top 130. These structural features correspond to those recited in the claims as “functional edges,” “functional surfaces,” or “tactilely perceptible boundaries” that assist in forming fold lines or orienting the jig relative to the paper element. FIG. 3B illustrates an alternative jig 121 having a tactile feature 132 and a perimeter 134, each of which is configured to be felt, detected, or traced to assist the user in placement, orientation, or alignment of the jig. FIG. 3C further illustrates jig 123 and shows exemplary dimensional relationships of its trapezoidal geometry. It is to be understood that the presently disclosed kit may have a plurality of jigs having differing configurations, sizes, or perimeter profiles associated with different origami designs.

The presently disclosed origami kit may comprise a plurality of jigs or templates having different shapes or sizes. For example, different sized angular, rectangular, or square jigs may be a part of the kit. One or more jigs may have openings or slots for guiding the folding of the paper. The variety of jigs may enable one with a visual impairment to form a variety of origami figures. One or more jigs may be used to form an origami figure. For example, the audio instructions may direct one to use a larger triangle to make one or more creases and then place a different jig against one of the formed creases or edges to guide the formation of additional creases.

In at least one embodiment, the presently disclosed origami kit comprises a plurality of jigs of different shape and/or size. In at least one other embodiment, the kit comprises a plurality of different sized and/or shaped pieces of paper for creating a variety of origami structures. In at least one additional embodiment, the audio instructions direct the maker to make a plurality of different origami structures using different pieces of paper and/or different jigs.

In at least one embodiment of the presently disclosure, a jig or template configured for origami formation is provided. The jig may have a variety of angular shapes, such as triangular, trapezoidal, square, rectangular, or polygonal.

In developing the method for forming a cup-shaped origami structure, the inventors recognized that visually impaired users require both a tactilely reliable reference system and a sequence of positional confirmations during folding. The act of first forming a crease that runs fully from one edge of the paper to the opposite edge enables the user to create a tactilely discernible midline that can be used repeatedly during subsequent steps. Once formed, this guiding crease acts as a physical landmark detectable by fingertip or fingernail tracing. Because the crease extends completely across the paper, it provides sensory continuity that helps the user align later folds and position the jig without relying on visual cues.

When placing the jig relative to the guiding crease, tactile edges of the jig allow the user to confirm its orientation by touch before executing the remaining folding steps. The jig's linear edges serve as fold-defining boundaries that enable predictable shaping of the paper. After the jig is enclosed within the folded portion of the paper, the user can determine its position by verifying that the jig is centered—an important condition that ensures both corners extend beyond the jig and can be independently folded to create the structural side edges of the cup. During formation of these side edges, the user may run fingers along the jig's edges to confirm proper contact and alignment, thereby assuring that each crease is made in the proper direction and location.

The method additionally provides for the user to tactilely confirm flap positions before folding them outward and downward. These flaps form the upper layers of the cup structure, and their correct positioning ensures clean overlap and functional rigidity once the jig is removed. Final tactile manipulation-squeezing the side edges inward-creates the three-dimensional cup shape and uses the geometry established through earlier jig-guided folds. This workflow allows the visually impaired user to build the cup structure entirely through tactile feedback, guided audio sequencing, and standardized geometries that prevent misalignment.

The inventors further recognized that enabling visually impaired users to construct a variety of origami structures requires both modularity and tactile distinguishability in the components of the kit. For this reason, the method includes selecting from multiple jigs, each having a configuration uniquely associated with a different final design. By providing jigs with distinct perimeters, edge geometries, or surface features, the user can identify each jig by touch and select the appropriate one as directed by audio instruction. Likewise, variations in paper elements—differences in shape, thickness, surface finish, or tactile pattern—allow users to distinguish among materials intended for different designs.

During operation, the user follows audio prompts to orient the chosen paper element and to place the selected jig onto specific regions of the paper. The edges and surfaces of the jig serve as tactile fold guides that the user can trace, press against, or align with prior creases. This ensures that the fold sequence remains accurate even when the user cannot visually judge distances or angles. If the paper includes tactile features-such as textured corners, raised markers, or distinctive perimeters—the user can feel these features to determine the intended orientation before folding.

As the folding sequence progresses, tactile feedback is used to confirm when paper layers have been properly bent, collapsed, or wrapped relative to the jig. For example, the user may assess tension changes, edge alignment, or paper resistance as indicators that a fold is complete. When the jig is removed, the partially formed structure retains the geometry imparted by the jig's edges. Final shaping then proceeds through additional tactile manipulation, allowing the user to collapse, pinch, open, or press the structure into the final three-dimensional form associated with the selected design. This approach enables a visually impaired user to construct multiple different origami structures using standardized tactile and instructional systems.

To support formation of different origami structures, the disclosed kit may include a selection of jigs that vary in shape, size, or boundary profile. Each jig incorporates one or more functional edges or tactilely distinct surfaces so that the user can feel the perimeter and identify the configuration by touch prior to use. These tactile distinctions may include raised profiles, indented regions, varying edge thicknesses, or uniquely shaped corners. The jigs may also be scaled proportionally to the paper elements intended for their associated designs, ensuring consistent fold geometry regardless of which jig is selected.

Similarly, the kit may include multiple paper elements that differ in format to suit the range of origami designs. The variations may include differences in overall dimensions, irregular geometric outlines, material thickness, or textured regions that guide tactile orientation. A textured or otherwise tactilely distinct feature can help the user determine top/bottom orientation or identify a specific starting edge purely through touch. In some embodiments, the paper is configured to permit formation of a tactilely perceptible guiding crease that remains detectable throughout the folding sequence.

The audio instruction resource coordinates all components of the kit by directing the user when to select a given jig, when to choose a corresponding paper element, and how to align the two relative to each other. The audio prompts may guide the user to form creases, locate tactile features, or follow specific edges of the jig to define folding lines. In some cases, the audio instructions explicitly reference tactile markers on the jig or paper so that the user can confirm alignment before proceeding. Through this integrated system, each step of the folding process is reinforced through a combination of audio sequencing and tactile confirmation, enabling reliable construction of diverse origami structures without requiring visual function.

### NOMENCLATURE

Kit 100
Jig 102, 120, 121, 123
Paper element 104
Origami structure 106
Printed Instructions 108, 109
Paper tactile feature 110
Kit contents list 112, 113
Printed instructions 114, 115
Audio instruction resource 111
Jig tactile feature 122, 132
First side of jig 124
Second side of jig 126
Second side of jig 128
Top of jig 130
Perimeter of jig 134

1. A method for the visually impaired to make a cup with origami comprising:
playing time-sequenced audio instructions for a visually impaired person to make the origami structure, wherein upon listening to the time-sequenced audio instructions the person performs the steps of:
placing a shaped piece of paper onto a flat surface;
folding and creasing the piece of paper a first instance to form a first crease that functions as a guiding crease and that completely extends between outer edges of the piece of paper;
unfolding the piece of paper;
placing a jig on the piece of paper and aligning a first linear edge of the jig with the first or guiding crease;
folding the piece of paper along the first crease and placing a portion of the piece of paper over the jig;
centering the jig within the folded piece of paper so that a first corner and a second corner extend beyond a second linear edge and a third linear edge of the jig and extending a first flap and a second flap beyond a top or fourth linear edge of the jig;
folding and creasing the first corner of the paper about the second linear edge of the jig and forming a first side edge of the cup;
folding and creasing the second corner of the paper about the third linear edge of the jig and forming a second side edge of the cup;
folding the first flap outwardly and down;
folding the second flap outwardly and down;
removing the jig from a top opening between the first side edge and the second side edge; and
squeezing the first side edge toward the second side edge and forming the cup.

2. The method of claim 1, further comprising pressing or tracing along the guiding crease to render the crease tactilely perceptible for use during subsequent folding and alignment steps.

3. The method of claim 1, further comprising feeling or tracing a tactile feature or perimeter of the shaped piece of paper to orient the piece of paper prior to forming the guiding crease.

4. The method of claim 1, further comprising feeling or tracing one or more edges or tactile boundaries of the jig to confirm proper orientation of the jig before aligning the first linear edge of the jig with the guiding crease.

5. The method of claim 1, wherein centering the jig within the folded piece of paper further comprises adjusting the jig by touch to ensure it remains positioned within the folded portion and does not extend beyond any edge of the folded piece of paper.

6. The method of claim 1, further comprising pressing or tracing along the second linear edge and the third linear edge of the jig to assist in forming the first side edge and the second side edge of the cup with tactile confirmation.

7. The method of claim 1, further comprising tactilely verifying the positions of the first flap and the second flap before folding them outwardly and down to ensure proper placement relative to the jig and the guiding crease.

8. A method for enabling a person with a visual impairment to create an origami structure, comprising:
playing audio instructions to the person, the audio instructions prompting the person to perform sequential folding and shaping actions;
selecting, in response to the audio instructions, one option from a plurality of jigs having differing configurations, each configuration being associated with formation of a different origami design;
selecting, in response to the audio instructions, one option from a plurality of paper elements having differing shapes, sizes, or tactile attributes for producing a desired origami result;
placing the selected paper element onto a working surface as instructed;
positioning the selected jig on the paper element and aligning one or more functional edges or functional surfaces of the jig with one or more regions of the paper element as directed by the audio instructions;
performing a sequence of folding actions in accordance with the audio instructions, the sequence comprising folding, bending, or shaping portions of the paper element relative to the jig;
removing the jig from the partially formed paper structure once the instructed folding sequence relative to the jig has been completed; and
finalizing the origami structure by folding, adjusting, pressing, or configuring the folded paper into the three-dimensional arrangement corresponding to the design selected through the audio instructions.

9. The method of claim 8, further comprising forming one or more guiding creases and creating a tactilely perceptible crease that serves as a reference line for subsequent folding actions.

10. The method of claim 9, further comprising using the guiding crease to locate, align, or position the selected jig relative to the paper element in response to the audio instructions.

11. The method of claim 8, further comprising feeling, detecting, or tracing one or more tactile features on the paper element to orient the paper element prior to performing the folding actions.

12. The method of claim 11, wherein orienting the paper element comprises following the perimeter of the paper element or a textured region of the paper element to determine its orientation by touch.

13. The method of claim 8, further comprising feeling, detecting, or tracing one or more tactile features on the selected jig to assist in placing, orienting, or centering the jig relative to the paper element.

14. The method of claim 13, wherein assisting in placement of the jig comprises following the outer perimeter or a tactilely distinct boundary of the jig to identify its orientation by touch.

15. The method of claim 8, further comprising interpreting tactile feedback during manipulation of the paper element to guide the user in shaping, pressing, redirecting, or collapsing the paper.

16. The method of claim 15, wherein selecting the jig comprises identifying, through tactile exploration or audio prompts, a jig configuration having a perimeter profile associated with a corresponding origami design.

17. The method of claim 8, wherein selecting the paper element comprises distinguishing, through tactile differences or audio instruction, among paper elements having differing sizes, shapes, or surface patterns.

18. A kit for enabling a person with a visual impairment to create an origami structure, comprising:
a plurality of jigs having differing configurations, each configuration being associated with formation of a different origami design and having one or more functional edges or functional surfaces configured to provide tactilely perceptible boundaries;
a plurality of paper elements having differing shapes, sizes, or tactile attributes for producing different origami results, each paper element having a perimeter or at least one tactilely perceptible feature configured to be sensed by touch by the person; and
an audio instruction resource configured to play audio instructions to the person, the audio instructions being associated with the plurality of jigs and the plurality of paper elements and being arranged to prompt the person to:
select, in response to the audio instructions, one of the plurality of jigs;
select, in response to the audio instructions, one of the plurality of paper elements;
place the selected paper element onto a working surface as instructed;
position the selected jig on the selected paper element and align one or more of the functional edges or functional surfaces of the jig with one or more regions of the paper element as directed by the audio instructions;
perform a sequence of folding actions in accordance with the audio instructions, the sequence including folding, bending, or shaping portions of the paper element relative to the jig and defining fold locations by tracing, pressing, or following the functional edges or functional surfaces of the jig;
remove the jig from a partially formed paper structure once an instructed folding sequence relative to the jig has been completed; and
finalize the origami structure by folding, adjusting, pressing, or configuring the folded paper into a three-dimensional arrangement corresponding to a design associated with the selected jig and the selected paper element.

19. The kit of claim 18 wherein the audio instructions further include prompts that direct the person to:
form one or more guiding creases in the selected paper element to create a tactilely perceptible crease that serves as a reference line for subsequent folding actions;
use the guiding crease to locate, align, or position the selected jig relative to the paper element; and
feel, detect, or trace the perimeter or tactile features of at least one of the selected paper element and the selected jig to orient the selected paper element and assist in placing, orienting, or centering the selected jig relative to the selected paper element.

20. The kit of claim 18, further comprising that at least one of the plurality of paper elements is preconfigured to enable formation of a guiding crease, the guiding crease being tactilely perceptible when formed and configured to assist the user in aligning or positioning any of the plurality of jigs on the paper element by touch.
